(19) United States
(12) Patent Application Publication
(10) Pub. No.: US 2004/0242213 A1
(43) Pub. Date: Dec. 2, 2004

(54) Network-based power up of a mobile unit

(76) Inventors: David S. Benco, Winfield, IL (US); Kevin J. Overend, Elmhurst, IL (US); Baoling S. Sheen, Naperville, IL (US); Sandra L. True, St. Charles, IL (US); Kenneth J. Voight, Sugar Grove, IL (US)

Correspondence Address: PATTI & BRILL, ONE NORTH LASALLE STREET, 44TH FLOOR, CHICAGO, IL, 60602, US

(21) Appl. No.: 10/452,355

(22) Filed: Jun. 2, 2003

(51) Int. Cl. H04M 3/42; H04M 1/00; H04B 1/38

(52) U.S. Cl. 455/415; 455/574

(57) ABSTRACT

A registered powered down condition is established in a mobile unit. A call directed to the mobile unit is determined to be associated with an authorized calling number. The mobile unit is powered up in response to the call if the call is associated with the authorized calling number. A switch maintains the mobile unit in the registered powered down condition and determines if the call directed to the mobile unit is associated with a profile associated with the mobile unit. The switch powers up the mobile unit if the call is associated with the profile.

### TECHNICAL FIELD

The invention relates generally to a mobile unit of a network and more specifically to a powering up of a powered down mobile unit.

### BACKGROUND

In order to prevent a mobile unit associated with a network in one example from initiating an alert for a call during an inconvenient time, for example, the mobile unit ringing during a meeting, the mobile unit is powered off. In another example, the mobile unit is powered off to conserve a battery-life associated with the mobile unit. Powering off the mobile unit prevents the mobile unit from receiving calls from the network. Unfortunately, where the mobile unit is powered off, an important or emergency call is missed and in one example is directed to voice mail associated with the mobile unit.

Therefore a need exists to select the calls received by the mobile unit when the mobile unit is powered off. A further need exists for the mobile unit to power up in order to receive the calls.

### SUMMARY

The invention in one embodiment encompasses a method. A registered powered down condition is established in a mobile unit. A call directed to the mobile unit is determined to be associated with an authorized calling number. The mobile unit is powered up in response to the call if the call is associated with the authorized calling number.

Another embodiment of the invention encompasses an apparatus. The apparatus comprises a mobile unit and a switch. The switch maintains the mobile unit in the registered powered down condition and determines if the call directed to the mobile unit is associated with the authorized calling number. The switch powers up the mobile unit if the call is associated with the authorized calling number.

Yet another embodiment of the invention encompasses an article. The article comprises one or more computer-readable signal-bearing media. The article comprises means in the one or more media for establishing a registered powered down condition in a mobile unit. The article comprises means in the one or more media for storing in a database an authorized calling number. The article comprises means in the one or more media determining if a call directed to the mobile unit is associated with the authorized calling number. The article comprises means in the one or more of the media for powering up the mobile unit in response to the call if the call is associated with the authorized calling number.

### DESCRIPTION OF THE DRAWINGS

Features of exemplary implementations of the invention will become apparent from the description, the claims, and the accompanying drawings in which:

FIG. 1 is a representation of one exemplary implementation of an apparatus that comprises a switch, a database, a network, a base station, a mobile unit, and a telephonic station.

FIG. 2 is a representation of an exemplary process flow of the network powering up the mobile unit of the apparatus of FIG. 1.

### DETAILED DESCRIPTION

The particular values and configurations discussed in these non-limiting examples can be varied and are cited merely to illustrate an embodiment of the present invention and are not intended to limit the scope of the invention.

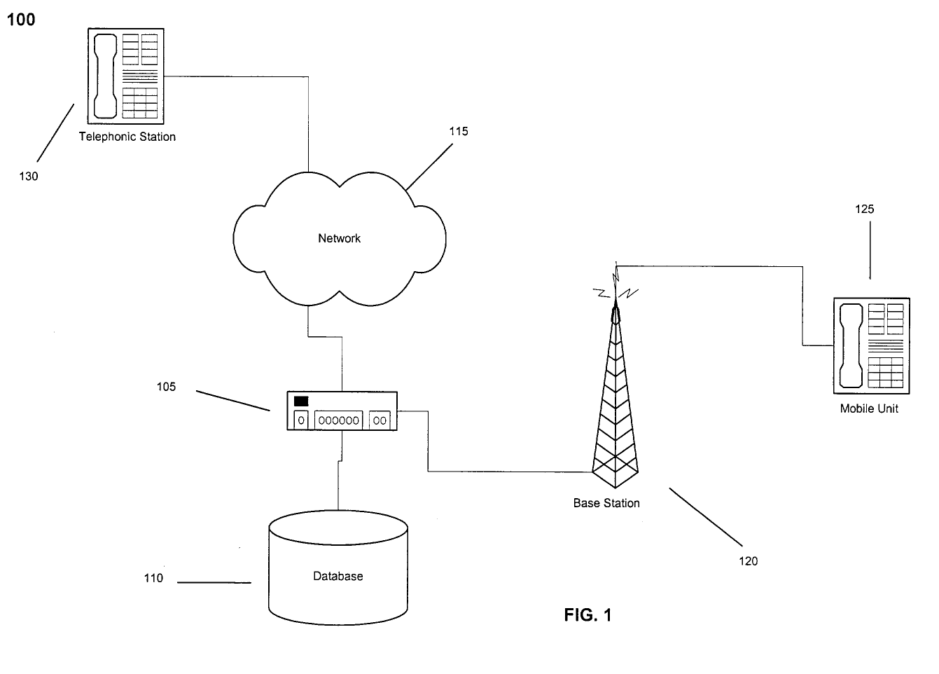

Turning to FIG. 1, an apparatus 100 in one example comprises a switch 105, a database 110, a network 115, a base station 120, a mobile unit 125, and a telephonic station 130. The network 115 comprises a telephone network, for example, a Public Switched Telephone Network (“PSTN”). The base station 120 comprises a cellular tower. The mobile unit 125 comprises a cellular phone. The telephonic station 130 comprises a telephony device, for example, a cellular phone or a land line phone.

The switch 105 communicates with the network 115 to receive a call from the telephonic station 130. The switch 105 communicates with the database 110 to retrieve a profile associated with a called party of the call, for example, the mobile unit 125. The switch 105 communicates with the network 115 to deliver a plurality of response options to the telephonic station 130. The switch 105 communicates with the base station 120 to power up the mobile unit 125. In one example, the switch 105 delivers to the telephonic station 130 a first response option of the plurality of response options to direct the call to a voice mail associated with the mobile unit 125. In another example, the switch 105 delivers to the telephonic station 130 a second response option of the plurality of response options to instruct the switch 105 to power up the mobile unit 125.

The switch 105 powers up the mobile unit 125 in one example by initiating a power up message to the mobile unit 125. The switch 105 maintains an option of powering off the mobile unit 125 associated with the mobile unit 125.

The database 110 stores the profile associated with the mobile unit 125. The profile comprises a plurality of authorized calling numbers associated with the mobile unit 125. A user of the mobile unit 125 employs a first user interface of the mobile unit 125 to provision the plurality of authorized calling numbers in the database 110. The plurality of authorized calling numbers indicates a plurality of calling numbers from which the user of the mobile unit 125 selects to receive calls.

In operation, the mobile unit 125 establishes one condition of either: a powered off condition; a registered powered down condition; and a powered up condition. An example of the registered powered down condition is disclosed in U.S. Pat. No. 6,463,307 issued to Larsson, et al. on Oct. 8, 2002 entitled Method and Apparatus for Power Saving in a Mobile Terminal with Established Connections, the disclosure of which is hereby incorporated by reference.

When the user of the mobile unit 125 initiates a powering off of the mobile unit 125, the mobile unit 125 provides to the user one or more options of powering off the mobile unit 125. A first option of the one or more options comprises the mobile unit 125 establishing the powered off condition, wherein the mobile unit 125 fails to receive all calls from the network 115. A second option of the one or more options comprises the mobile unit 125 establishing the registered powered down condition, wherein the mobile unit 125 receives the calls indicated by the plurality of authorized calling numbers. The mobile unit 125 communicates with the switch 105 to indicate the option selected of the one or more options of powering off the mobile unit 125. The switch 105 employs the option of powering off the mobile unit 125 to power up the mobile unit 125.

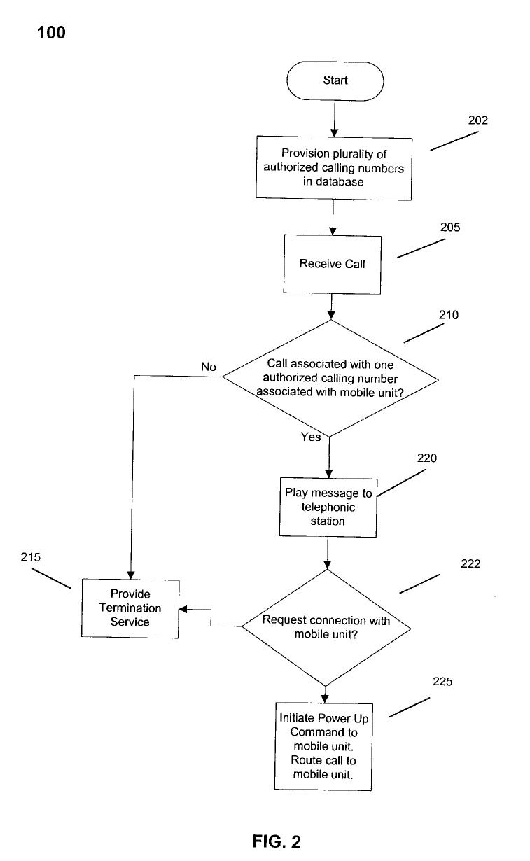

Referring to FIG. 2, the mobile unit 125 establishes the registered powered down condition. In the STEP 202, the user of the mobile unit 125 employs the first user interface to provision the plurality of authorized calling numbers into the database 110. In the STEP 205, the telephonic station 130 initiates the call destined for the mobile unit 125 that is received by the switch 105. In STEP 210, the switch 105 determines if the call is associated with one authorized calling number of the plurality of authorized calling numbers of the profile associated with the mobile unit 125. In STEP 215, the call is routed to the voice mail associated with the mobile unit 125 where the call is not associated with the one authorized calling number.

In STEP 220, the switch 105 delivers to the telephonic station 130 the plurality of response options where the call is associated with the one authorized calling number. The switch 105 in one example plays a message to a user of the telephonic station 130 indicating a delay in routing the call to the mobile unit 125. The delay corresponds to a duration of time for the mobile unit 125 to establish the powered up condition from the registered powered down condition. For example, the switch 105 plays the message to the user of the telephonic station 130 indicating the delay for the mobile unit 125 to power up comprises 20 seconds.

In STEP 215, the user of the telephonic station 130 selects the first response option to direct the call to the voice mail associated with the mobile unit 125. In STEP 222, the user of the telephonic station 130 selects the second response option to instruct the switch 105 to power up the mobile unit 125. In STEP 225, the switch 105 powers up the mobile unit 125 and routes the call to the mobile unit 125 where the call is associated with the one authorized calling number.

The steps or operations described herein are just exemplary. There may be many variations to these steps or operations without departing from the spirit of the invention. For instance, the steps may be performed in a differing order, or steps may be added, deleted, or modified.

The apparatus 100 employs at least one computer-readable signal-bearing medium. One example of a computer-readable signal-bearing medium for the apparatus 100 comprises an instance of a recordable data storage medium such as one or more of a magnetic, electrical, optical, biological, and atomic data storage medium. The recordable data storage medium in one example comprises the storage devices 101 and 201. In another example, a computer-readable signal-bearing medium for the apparatus 100 comprises a modulated carrier signal transmitted over a network comprising or coupled with the apparatus 100, for instance, one or more of a telephone network, a local area network (“LAN”), the internet, and a wireless network. An exemplary component of the apparatus 100 employs and/or comprises a set and/or series of computer instructions written in or implemented with any of a number of programming languages, as will be appreciated by those skilled in the art.

Although exemplary implementations of the invention have been depicted and described in detail herein, it will be apparent to those skilled in the relevant art that various modifications, additions, substitutions, and the like can be made without departing from the spirit of the invention and these are therefore considered to be within the scope of the invention the following claims.

We claim:

1. A method, comprising the steps of:
establishing a registered powered down condition in a mobile unit;
determining if a call directed to the mobile unit is associated with an authorized calling number; and
powering up the mobile unit in response to the call if the call is associated with the authorized calling number.

2. The method of claim 1, further comprising the step of storing in a database the authorized calling number, and wherein the step of determining comprises the step of determining if the call is associated with the authorized calling number stored in the database.

3. The method of claim 2, wherein the step of storing further comprises the step of storing at one of at least one of a plurality of authorized calling numbers stored in the database

4. The method of claim 1, further comprising the steps of:
upon determining that the call is associated with an authorized calling number and prior to powering up the mobile unit, delivering to a telephonic station associated with the call a plurality of response options; and
initiating one of the plurality of response options.

5. The method of claim 4, wherein one of the plurality of response options comprises the step of instructing the network to power up the mobile unit.

6. The method of claim 4, wherein one of the plurality of response options comprises the step of directing the call to a voice mail associated the mobile unit.

7. The method of claim 1, further comprises the steps of:
after powering up the mobile unit, initiating a power down of the mobile unit; and
in response to a prompt, powering off the mobile unit.

8. The method of claim 1, further comprises the steps of:
after powering up the mobile unit, initiating a power down of the mobile unit; and
in response to a prompt, establishing the registered power down condition for the mobile unit.

9. An apparatus, comprising;
a mobile unit; and
a switch that maintains the mobile unit in a registered powered down condition and determines if a call directed to the mobile unit is associated with a profile associated with the mobile unit and powers up the mobile unit if the call is associated with the profile.

10. The apparatus of claim 9, wherein the comprises an authorized calling number.

11. The apparatus of claim 10, further comprising a database that stores the authorized calling number, and wherein the authorized calling number is one of at least one of a plurality of authorized calling numbers.

12. The apparatus of claim 10, wherein upon when the call is associated with an authorized calling number and prior to powering up the mobile unit, the switch delivers to a telephonic station associated with the call a plurality of response options and initiates with the network one of the plurality of response options by the telephonic station.

13. The apparatus of claim 12, wherein one of the plurality of response options comprises the switch instructing the network to power up the mobile unit.

14. The apparatus of claim 12, wherein one of the plurality of response options comprises the switch instructing the network to send the call to a voice mail associated the mobile unit.

15. The apparatus of claim 10, wherein after the mobile unit is powered up and upon initiating a power down of the mobile unit the switch in response to a request at the mobile unit powers off the mobile unit.

16. The apparatus of claim 10, wherein after the mobile unit is powered up and upon initiating a power down of the mobile unit, the switch in response to a request at the mobile unit establishes the mobile unit in the registered powered off condition.

17. An article, comprising:
one or more computer-readable signal-bearing media:
means in the one or more media for establishing a registered powered down condition in a mobile unit;
means in the one or more of the media for storing in a database an authorized calling number;
means in the one or more of the media for determining if a call directed to the mobile unit is associated with the authorized calling number; and
means in the one or more of the media for powering up the mobile unit in response to the call if the call is associated with the authorized calling number.
